(19) United States
(12) Patent Application Publication
(10) Pub. No.: US 2016/0273601 A1
(43) Pub. Date: Sep. 22, 2016

(54) METHOD FOR PRODUCING A BRAKE DISK AND BRAKE DISK

(71) Applicant: FORD GLOBAL TECHNOLOGIES, LLC, Dearborn, MI (US)

(72) Inventors: Maik BRODA, Wuerselen (DE); Ivan BRUGGEN, Riemst (BE); Tomasz Pawel GRABIEC, Bergisch Gladbach (DE); Clemens Maria VERPOORT, Monheim (DE)

(21) Appl. No.: 15/031,895

(22) PCT Filed: Oct. 15, 2014
(86) PCT No.: PCT/EP2014/072130

§ 371 Date: Apr. 25, 2016

(30) Foreign Application Priority Data
Oct. 25, 2013 (DE) 10 2013 221 737.4

(51) Int. Cl. F16D 65/12; C23D 5/00

(52) U.S. Cl. CPC F16D 65/127; C23D 5/10; F16D 2200/0043; F16D 2250/0046

(57) ABSTRACT

A method for producing a brake disk for a vehicle having a protective layer applied on a main body of the brake disk. The method includes the steps of:
premachining a region of the main body of the blank;
applying an enamel coating to the region of the main body, and
treating the enamel coating on the region of the main body to metallurgically bond the enamel coating to the base material of the main body by phase formation.

### CROSS-REFERENCE TO RELATED APPLICATIONS

This application claims priority from International Application No. PCT/EP2014/072130, filed Oct. 15, 2014 that claims priority to German Patent Application No. DE 10 2013 221 737.4, filed Oct. 25, 2013, the disclosures of which are hereby incorporated in their entirety by reference herein.

### TECHNICAL FIELD

The present invention relates to a method for producing a brake disk for a vehicle and to a brake disk for a vehicle.

### BACKGROUND

DE AS 1 625 680 concerns a friction body for wet clutches and brakes, having a support and at least one sintered, porous and metallic friction lining applied to the support. The proposal was that the friction lining should be composed of metal fibers, wherein the degree of porosity was to be at least 50%.

DE 10 2010 049 797 A1 discloses that a brake disk can be produced integrally with a wheel hub, the intention being to enable the run out of the brake disk to be reduced. Moreover, the friction surfaces of the brake disk could be provided with a friction coating, which can be composed of a hard metal or of a ceramic.

EP 1 987 267 B1 is concerned with a brake disk which is based on the use of materials of which one is supposed to perform a structural function and the other is supposed to perform a braking function. The brake disk comprises a supporting or structural disk, the sides of which are equipped with a first and a second friction disk. The friction disks are produced from a material suitable for performing the braking function. The structural disk is produced from composite material. The composite material of the structural disk can be composed of a resin, chosen from among epoxy, phenolic, cyanate ester, cyano epoxy, ceramic resins and enamel or a combination of these. The friction disks can be produced from a material chosen from among steel, cast iron, hardened aluminum, aluminum oxide (ceramic), silicon carbide, silicon nitride, titanium carbide and carbon-ceramic.

On vehicles, especially motor vehicles, disk brakes form what is probably the most widely distributed type of brake system. Disk brakes consist essentially of a brake disk and a brake caliper, which fits around the edge of the brake disk. In this arrangement, the brake disk is connected by a wheel hub mounted rotatably in the steering knuckle to the vehicle wheel to be braked. In contrast, the brake caliper is fixed on the steering knuckle. The actual retardation is achieved by brake pads which can be placed against the brake disk, said pads being arranged on both sides of the brake disk, between the latter and the brake caliper.

Depending on the application, brake disks can be composed either of iron, e.g. grey cast iron or, alternatively, of carbon-ceramic or aluminum. At the same time, brake disks should have a surface which exhibits as little wear as possible and releases little fine dust. To achieve this, the aim is a surface which is as hard as possible. Thus, in the case of brake disks made of aluminum for example, silicon carbide (SiC) is added in an appropriate manner, being deposited as a wear-resistant protective coating on the surface. However, producing brake disks made of nonferrous materials is in some cases difficult and usually expensive.

Another form of embodiment of such a protective layer can be achieved by thermal spraying. In this process, the material to be applied to the surface of a main body of the brake disk is softened in advance by the action of heat and is accelerated in the form of individual particles by means of a gas stream. Upon impact of the particles, a purely mechanical bond is formed without melting of the surface of the main body. The materials can be metals or oxide-ceramic or carbide materials. The disadvantage here, apart from the high costs, is especially the durability of such protective layers. Thus, only moderate roughening of the surface by means of sandblasting is generally possible, and this does not lead to a permanent mechanical bond. Specifically when using hard cast iron for the main body, dovetail roughening, which is advantageous per se, is not possible, for example.

In the process of abrasion between the brake lining and the brake disk, particle emissions, i.e. fine dust, occur. Apart from the problem of fine dust, however, the optical effect of rusted brake disks in combination with expensive aluminum rims plays an additional role. It is known that about 70% of the fine dust particles stem from the grey cast iron disk material. The temperature at which these particles produced by wear strike the aluminum rim is very high, being up to 700° C. In the process, they can simply burn into the clear coating on the aluminum surface, and the removal of the grey-black coating is very difficult, even in a car wash and with the greatest care. Moreover, squealing noises or brake judder in the case of linings that have rusted on after being stationary for a prolonged period are additionally regarded as troublesome.

It would be possible to catch the fine dust particles formed by means of a kind of vacuum cleaner behind the brake disk and to collect them in a filter element, e.g. in a paper filter. Although it is thereby possible to prevent or minimize pollution of the environment or the formation of dirty aluminum rims, the basic problem of wear and corrosion is not solved by this means.

It is also possible to provide what are referred to as temporary low-cost protective layers to enable the vehicles to at least reach the dealer from the manufacturer without the brand-new vehicle having to be displayed in the dealer showroom with rusty brake disks. These are generally pigmented spray-on layers containing zinc pigments. On the other hand, there are known brake systems in which zinc is rubbed onto the grey cast iron surface during the braking process, thereby giving rise to cathodic corrosion protection. On the other hand, this zinc film has a negative effect on the friction function of the brake lining, and the friction coefficients decrease.

Coating by nitriding-diffusion based on iron nitride would also be possible. This coating leads to short-term wear and corrosion protection; however, the life of this coating is limited. In countries with high speed limits for vehicles, e.g. Germany, this results in high braking temperatures, for which reason NAO linings are not suitable in these countries. Moreover, the process is very time-consuming and is very expensive owing to the large furnace chambers required.

Numerous thermal spraying methods (already mentioned above) and electrolytic coating methods are likewise used. These layers are very expensive to produce. In the case of electrolytic methods, the entire component must be coated with chromium or nickel or nickel plus particles of hard material. However, both such electrolytic coatings and thermally sprayed coatings tend to perform poorly in salt spray tests. Thus, the undermining of thermal spray layers cannot be reliably avoided, even with additional sealing methods.

In view of the prior art indicated, there is still room for improvement in the simple and durable manufacture of brake disks as mass-produced articles.

### SUMMARY

Given this background situation, it is the underlying object of the invention to present a method for producing a brake disk for a vehicle, which method allows low-cost and yet durable mass production. Moreover, the intention is to indicate a brake disk for a vehicle which, in addition to low-cost manufacture, has, in particular, improved resistance to corrosive attack and an improved life.

The part of the object pertaining to a method is achieved in the measures of claim 1. The part of said object pertaining to a product is achieved by a brake disk having the features of claim 11. Further particularly advantageous embodiments of the invention are disclosed by the respective dependent claims.

It should be noted that the features and measures presented individually in the following description can be combined in any technically feasible manner and give rise to further embodiments of the invention. The description additionally characterizes and specifies the invention, especially in conjunction with the figures.

According to the invention, a method for producing a brake disk for a vehicle is presented below, in which method a protective layer is arranged on a main body of the brake disk at least in some region or regions. According to the invention, the method comprises at least the following steps:
premachining at least some region or regions of the main body present in the blank;
applying an enamel coating to the main body at least in some region or regions, and
aftertreating the main body coated at least in some region or regions, wherein the enamel coating bonds metallurgically to the base material of the main body by phase formation.

The enamel coating according to the invention is preferably a fused mixture. At the enameling temperature, the glass-forming oxides fuse to form a glass melt. Here, glass-forming oxides can be SiO₂, B₂O₃, Na₂O, K₂O and Al₂O₃. Base enamels contain about 23-34% by weight borax, 28-52% by weight feldspar, 5-20% by weight quartz, about 5% by weight fluoride, the remainder being sodium carbonate and sodium nitrate. The oxides of Ti, Zr and Mo can be used as opacifiers.

To ensure that the enamel coating adheres firmly to the metallic substrate, i.e. to the base material of the main body, cobalt oxides, manganese oxides or nickel oxides are provided as constituents, for example. It is also possible to use ceramic pigments, such as iron oxides, chromium oxides and spinels.

In a preferred embodiment, the substances mentioned are finely ground and melted. The melt is quenched, that is to say preferably added to water, wherein the granular glass-type frit thus formed is once again finely ground in the next step. During the grinding process, 30% to 40% of water together with clay and silica flour are added, for example. Depending on the type of enamel, the opacifiers and pigment oxides mentioned are also added.

In this way, an enamel slip is formed, which should rest for a certain time, preferably several days, to ensure better mixing before the enamel slip is used further. Suitable floating agents are used to ensure that a uniform layer thickness is obtained, after a dip coating for example, and a possible dip coating process will be explained in greater detail.

The brake disk, i.e. the main body thereof, is preferably produced by means of sand casting. In this case, the main body, i.e. the blank, has an encircling outer brake ring, which is provided for contact with a brake pad of a brake caliper, wherein, of course, the brake pads or brake linings engage on both sides of the brake ring, i.e. friction surfaces. Provided in the center of the main body is an opening, which is arranged in a projection of the main body. Arranged around the opening, at uniform intervals, there are preferably five through holes through the projection. Said through holes serve to receive wheel bolts, by means of which the brake disk, together with a wheel, can be connected to a wheel hub. The projection, which can also be referred to as a disk hat, can be produced integrally with the brake ring, i.e. cast, or connected in a suitable manner to the brake ring as a separate element. The main body can be produced as an unventilated or ventilated brake disk, this being known per se. In the case of the ventilated brake disk, the friction surfaces are arranged on cover disks, wherein the opposite cover disks are spaced apart by ribs. Of course, each cover disk also has only one friction surface, but this is known per se. Thus, an air gap is formed between the cover disks, although this is known per se and therefore no further details will be given thereof.

This blank is then premachined, at least in some region or regions, wherein the future friction surfaces, in particular, are premachined. Premachining can be accomplished by means of mechanical methods, wherein premachining is preferably performed by means of turning methods, more preferably by means of dry turning methods (dry turning). In this case, the regions to be coated, that is to say, for example, the friction surfaces, are preferably machined in such a way that they have a roughness of 6 to 7 μm, for example. Sandblasting is also possible for the purpose of premachining, and there is no intention to exclude other suitable premachining methods.

Once at least the friction surfaces have been premachined, the enamel coating can be applied. This can be accomplished by means of spraying, although application by brushing or in a dipping bath may also be expedient. Thus, it is expedient if the coating, i.e. the enamel slip, is applied as a wet enamel coating.

In the case of application by spraying, provision is expediently made for the enamel coating to be applied as an aqueous suspension (enamel slip). It is advantageous here that at least the premachined region is very readily accessible since the spraying device can cover the region to be coated on an individual basis. The coating can be applied in such a way that the main body is preferably rotating. It is possible to make the brake disk rotate at 80 rpm. The enamel coating can be sprayed on at a pressure of 2 to 4 bar, for example, by atomization with compressed air. In this way, the enamel coating can be applied in the desired material thickness within a very short time of, for example, 20 seconds, wherein the delivery rates of the enamel slip can be controlled within narrow limits by automatic parameter monitoring, by means of computer-controlled spraying robots for example, in order to be able to produce the respective enamel coating with small thickness fluctuations in each case. In the method according to the invention, a single-stage enamel coating process is preferably chosen. This makes it possible to dispense with the separate application of a base enamel and a topcoat enamel since only a single-stage application is preferred. A rotating spraying device and a fixed disk brake to be coated are also possible but not preferred. Thus, it is possible to provide only the region of the friction surfaces with the enamel coating. This can be carried out in this way on unventilated brake disks but also on ventilated brake disks. As a further possible embodiment, the main body can be coated in a dipping bath, wherein an aqueous solution (enamel slip) is likewise provided. In this case too, it is possible to coat only the brake ring, i.e. only the friction surfaces. In this process, the main body is not dipped completely into the dipping bath but only to a depth such that the brake ring dips in over a certain area. By rotating the brake disk, the entire brake ring is thus coated. It is expedient to provide a ventilated brake disk, in particular, with the enamel coating by means of the dipping bath since the wet enamel coating can also enter fully into the interspace between the two cover disks, thus allowing even the inner surfaces opposite the friction surfaces to be coated, while, of course, the ribs can likewise be coated.

Instead of partial coating, in which only the brake ring, i.e. the friction surfaces, is/are coated, it is also possible for the main body to be completely coated. Thus, the brake disk is then fully protected against corrosion. Provision is then expediently made for the main body to be fully premachined too.

Once again, it is possible here to provide for enamel coating by means of a spraying device or in a dipping bath. In a dipping bath, the brake disk is fully immersed if the brake disk is to be fully coated. Rotation of said brake disk is not necessary but may be desired. If the enamel coating is applied by means of the spraying device, it is possible to apply enamel coatings which differ at least in color. The projection, i.e. the disk hat, for example, could also be embodied so as to be luminous in low light conditions. This is appropriate since the projection itself is not exposed to any frictional forces like the friction surfaces. Nevertheless, it would, of course, also be possible to embody the friction surfaces with a certain color if it were ensured that the color remained unchanged even after engagement of the brake linings, i.e. after wear on the respective friction surfaces.

If the brake disk is at least partially coated, it is aftertreated in a further step. For this purpose, provision is advantageously made for the enamel coating first of all to be dried after application, whereupon a baking treatment is provided. To dry the enamel coating, the brake disk is fed to a drying device, wherein the enamel-coated brake disk is dried at about 90 to 120° C., or at about 80 to 100° C., for a period of 5 to 30 minutes. In a preferred embodiment of the method, the drying process can be performed in an air-circulating furnace. For the subsequent heat treatment, the enamel-coated brake disk is baked in a continuous furnace at about 800 to 940° C., for example. This allows the enamel coating to bond metallurgically to the base material of the main body by phase formation. During this stoving process, the formation of a thick, continuous oxide layer is achieved, which is very resistant to corrosive attack by rainwater and, in particular, also salt water.

Enamel coatings according to the invention are distinguished from electrolytic or spray coatings in that they cannot be undermined. If protective layers are undermined, the iron oxide phase forms underneath the coating, which then leads to a large increase in volume associated with flaking of the covering layer. It is also conducive to success that enamel coatings according to the invention cannot suffer further damage even if the layer is removed down to the base material by local damage (stone impact, mechanical damage). Rust damage would then occur only in the region of the missing enamel coating but would not spread further. Another advantage of the enamel coating according to the invention is to be regarded as the fact that it has a very low weight, this being attributable to the chemical composition of the aluminum oxides, silicates etc. and to the pores and bubble structure typical of enamel.

In addition to this good corrosion resistance, the enamel coating according to the invention is distinguished by good wear resistance by virtue of high layer hardness, which can be up to three times greater than that of the grey cast iron base material. Resistance to wear and/or thermal cracks can be further enhanced by the use of “partially crystalline enamels”, in which crystallizing deposits in the glass matrix increase wear resistance as compared with conventional enamels. Also conducive to success is the fact that the wear behavior of the enamel can be drastically improved by incorporating nanoscale hard materials. These carbide hard materials have significantly greater resistance to wear than the amorphous enamel matrix. Wear resistance can be further optimized by varying the carbide particle size.

Grey cast iron can preferably be used as a base material.

After the stoving step, the enamel coating surface optionally can be subjected to a final treatment, i.e. a finish. Provision is preferably made to machine the friction surfaces by turning and to remove the layer of scale formed due to the baking process.

It is, of course, possible for the brake disks to be used without any machining in the region of the friction surface. By using thinner enamel layers and using induction coils for sintering the layers combined with rotary motion, any possible radial run out and also roughness can be minimized. Finish machining of the disks by a finish grinding operation is also possible, wherein diamond or carbide cup wheels are used. Finish machining by means of turning is conceivable, this being feasible despite the high hardness owing to brittleness, wherein polycrystalline diamond indexable inserts are preferred.

It is conducive to success if an enamel coating with a layer thickness of 50 μm to 1000 μm is applied. It is thereby possible to produce brake disks which could have a life of more than 240,000 km, depending on the layer thickness of the enamel coating.

To ensure that the wear resistance is high enough, it has proven useful to adapt the composition of the enamel coating in such a way that, after sintering, i.e. after the baking process, the hardness values are >650 HV0.1. Moreover, this composition results in a glass-type enamel coating which is not completely fused and does not have the smooth surfaces typical of enamel but rather a rough surface caused by the higher proportion of crystalline phases. Ideally, the proportion of crystal can be 20% but also 30-50%.

By virtue of the outstanding corrosion and wear resistance of the friction layer, the enameling method according to the invention is particularly suitable for the production of brake disks. Moreover, the method according to the invention offers the possibility of adjusting the friction coefficients within wide limits in such a way, through the addition of certain oxides, that conventional friction linings can be used, wherein both corrosion resistance and wear resistance are considerably improved in relation to conventional grey cast iron brake disks.

In addition, the enamel coating can be pigmented, making it possible to choose different colors on an individual basis, as already mentioned above.

By means of the invention, it is possible to apply an enamel coating over the entire brake disk as corrosion protection (prevention of red rust), wherein it is also possible for the enamel coating to be applied only in the region of the friction surface, as a wear coating with a suitable friction coefficient (avoidance of grinding noise). The enamel coating can be applied as a decorative, easy-clean coating in the region outside the friction lining contact surface, wherein the enamel coating can be applied in the contact region in order to prevent the removal of the brake disk (prevention of rusting onto the wheel hub). The method according to the invention can comprise the steps of premachining, application of the slip by dipping/spraying, drying and sintering and finishing work to obtain a desired roughness. The enamel coating can furthermore have a heat-insulating effect, with the result that the heat which arises is not dissipated as quickly.

Although a single-stage coating method is preferred, it is possible for the disk to dip fully into a low-cost enamel slip, this being expedient particularly in the case of ventilated disks with the large number of ribs between the two cover disks, in which case an expensive, high grade colored enamel layer is then applied in a subsequent spray application in the region between the friction lining surface and the cup contact surface (disk hat). In principle, no rust particles can form on the enamel coating, and therefore a problem with grinding noise such as that which can occur with conventional grey cast iron brake disks is avoided.

The edges of the main body, which are provided with an enamel coating, preferably have a radius R which is at least 3 times larger than the layer thickness of the enamel coating in the region of the radius of the edges. A uniform layer thickness in the region of edges is thereby ensured. If the transitions or edges are too sharp, the enamel layer which forms there will be too thin.

### BRIEF DESCRIPTION OF THE DRAWINGS

Further advantageous details and effects of the invention are explained in greater detail below by means of different illustrative embodiments shown in the figures, of which:

FIG. 1 shows a schematic illustration of a brake disk according to the invention in a plan view,

FIG. 2 shows the brake disk from FIG. 1 in section,

FIG. 3 shows a detail of FIG. 2, and

FIG. 4 shows an alternative ventilated brake disk embodiment in a perspective cut-away view.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the various figures, identical parts are always provided with the same reference signs, and therefore these are generally also described only once.

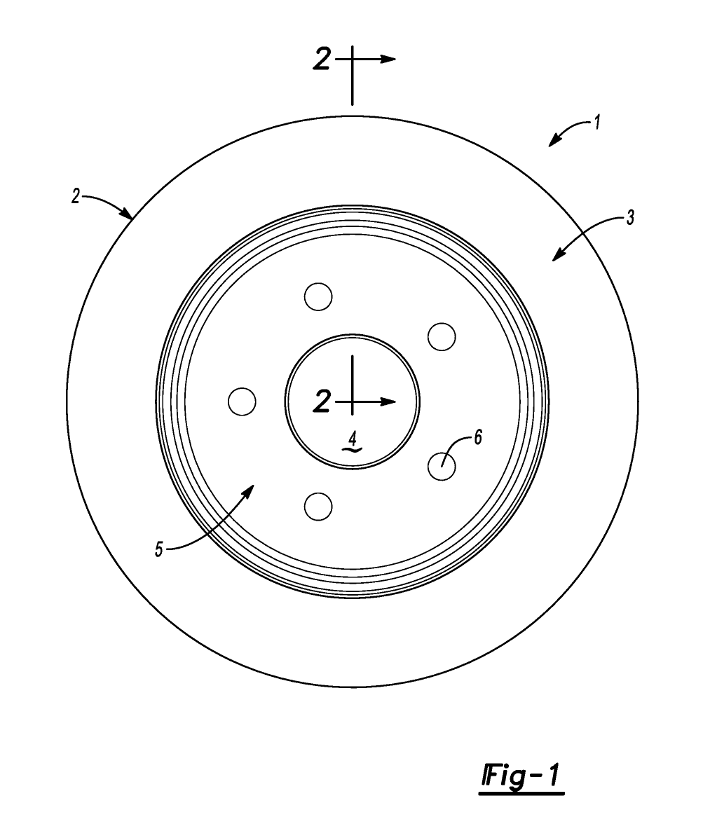

FIG. 1 shows a schematic illustration of a brake disk 1 according to the invention. This has a circular main body 2, consisting, by way of example, of cast iron, or for example, grey cast iron. The main body 2 has an encircling outer brake ring 3, which is provided for contact with a brake lining (not shown specifically). An opening 4 is provided in the center of the main body 2, and is arranged in a projection 5 of the main body 2. The projection 5 can also be referred to as a disk hat 5. Five through holes 6 through the projection 5 are arranged at uniform intervals around the opening 4. Through holes 6 receive wheel bolts (not shown specifically here), by means of which the brake disk 1, together with a wheel (not shown), can be connected to a wheel hub (likewise not shown).

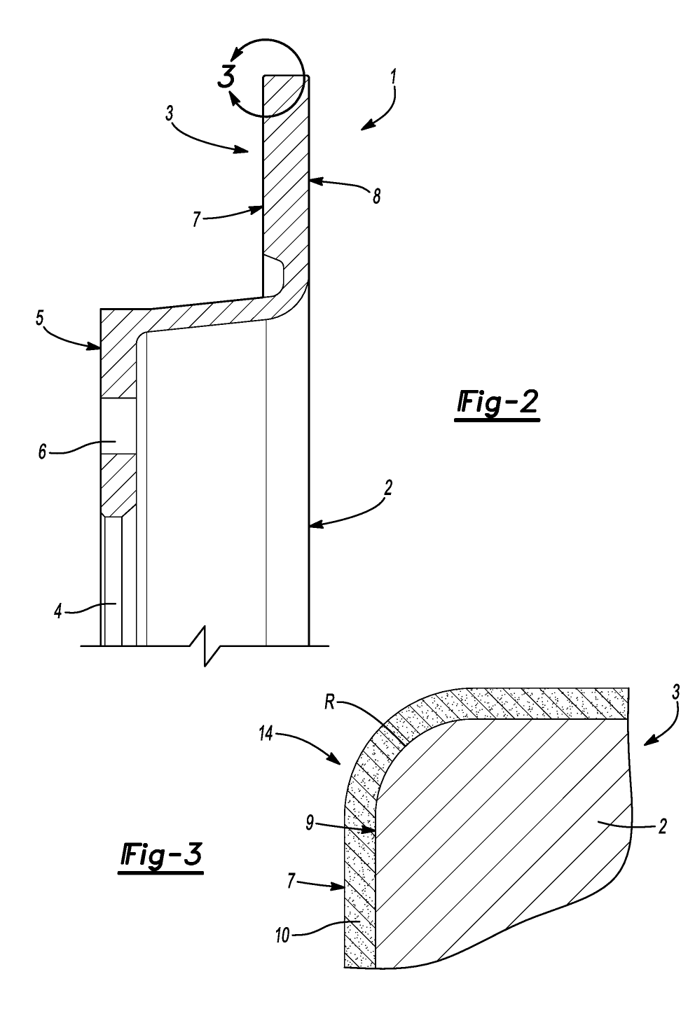

FIG. 2 shows a section through the plane a-a of the brake disk 1 from FIG. 1. The projection 5 projects relative to the brake ring 3 of the main body 2. The brake ring 3 comprises two braking surfaces, i.e. friction surfaces 7, 8, aligned parallel to one another, that is to say a first friction surface 7 and a second friction surface 8. A chain-dotted circle B is drawn in FIG. 2, to indicate the region of the brake ring 3 shown in FIG. 3.

The enlargement of the brake ring 3 in the region of the first friction surface 7 illustrates an enamel coating 10 applied in this region to a surface 9 of the main body 2. The enamel coating 10 also covers the outer circumferential surface and the entire brake disk 1 can have an enamel coating 10. However, it is also conceivable for only the friction surfaces 7 and 8 to have the enamel coating 10.

The edge 14 is embodied with a radius R to ensure that a uniform enamel layer is applied in this region. Here, the radius R is approximately 3 times the layer thickness of the enamel coating 10. Larger radii are unproblematic but, in the case of smaller radii, the layer thickness may be unevenly distributed in the region of the edge 14.

The enamel coating 10 can also be applied to the brake disk at least in some region or regions, wherein only the friction surfaces 7 and 8 are provided with the enamel coating 10. However, it is also possible, as mentioned, to provide the brake disk 1 completely with the enamel coating. The enamel coating can be applied by means of spraying devices or in a dipping bath.

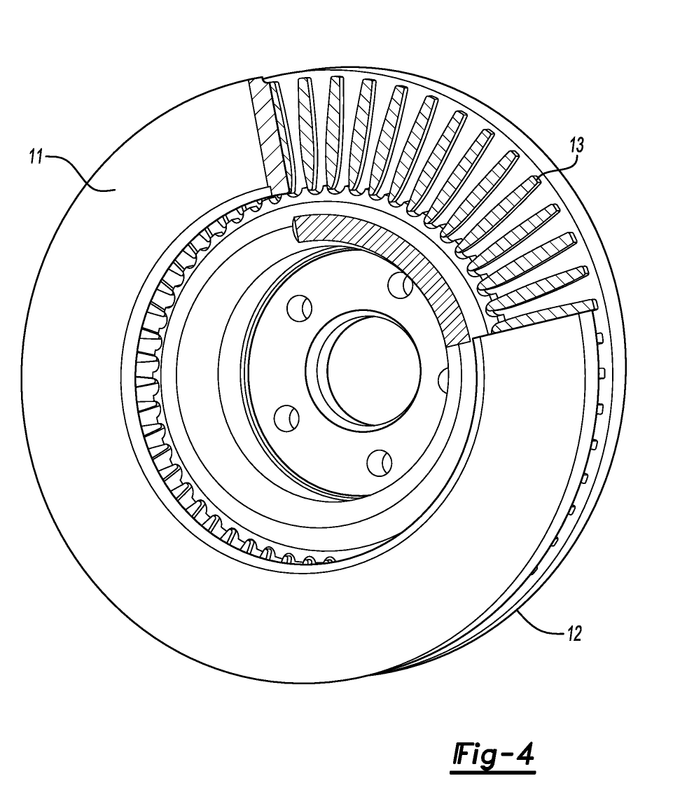

FIG. 4 shows a brake disk 1 which has cover disks 11 and 12, between which ribs 13 are arranged, thus forming a ventilated brake disk 1. The ventilated brake disk can also have the enamel coating 10 only on its friction surfaces 7 and 8. However, it is advantageous if the ventilated brake disk 1 is completely coated with enamel. For this purpose, the ventilated brake disk 1 can be dipped into a dipping bath, with the result that the inner surfaces of the mutually opposite cover disks 11 and 12 as well as the ribs 13 are also coated with enamel.

It is also possible for the brake disk 1 to have different enamel coatings. Thus, it is preferably possible to select a coating on the friction surfaces 7 and 8 which has required friction coefficients, thus ensuring that the function of the brake disk 1 is maintained. On the surfaces outside those required to decelerate the vehicle, the brake disk can have an enamel coating, which has, for example, signaling effects in the form of colors which are luminous, even in the dark. It is also entirely consonant with the invention to provide the friction surfaces with a corresponding enamel coating that has a signaling effect.

In all cases, the brake disk should be premachined at least in some region or regions before the application of the enamel coating 10. It is advantageous to machine the region of the brake disk 1 which is also to be coated.

After the application of the enamel coating 10, drying and baking is envisaged. As an option, a mechanical finish machining operation can also be performed.

### LIST OF REFERENCE SIGNS

1 brake disk
2 main body
3 brake ring
4 opening
5 projection/disk hat
6 through hole
7 first braking surface/friction surface
8 second braking surface/friction surface
9 surface
10 enamel coating
11 cover disk
12 cover disk
13 ribs
14 edge
R radius

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-20. (canceled)

21. A method for producing a brake disk for a vehicle, comprising:
pre-machining at least one braking surface of the brake disk;
applying an enamel coating to the at least one braking surface; and
bonding the enamel coating metallurgically to the at least one braking surface, wherein the enamel coating bonds to the to the at least one braking surface by phase formation.

22. The method of claim 21 wherein the enamel coating is a fused mixture, that contains glass-forming oxides as well as borax, feldspar, quartz, fluoride, sodium carbonate, sodium nitrate and opacifiers.

23. The method of claim 22 wherein the enamel coating contains cobalt oxides, manganese oxides and/or nickel oxides.

24. The method of claim 21 wherein the enamel coating contains cobalt oxides, manganese oxides and/or nickel oxides.

25. The method of claim 21 wherein the at least one braking surface further comprises:
a first friction surface; and
a second friction surface.

26. The method of claim 21 wherein the step of pre-machining the at least one braking surface is performed by dry turning the braking surface.

27. The method of claim 21 wherein the at least one braking surface is pre-machined to have a roughness of between 6 to 7 μm.

28. The method of claim 21 wherein the step of applying the enamel coating is performed by spraying the enamel coating on the at least one braking surface.

29. The method of claim 21 wherein the step of applying the enamel coating is performed by dipping the at least one braking surface into a dipping bath of the enamel coating.

30. The method of claim 21 further comprising:
drying the enamel coating on the at least one braking surface; and
baking the enamel coating.

31. The method of claim 30 further comprising:
machining the enamel coating with a mechanical finishing tool.

32. A brake disk for a vehicle comprising:
a main body;
a first braking surface and a second braking surface formed on the main body; and
an enamel coating applied to the first braking surface and the second braking surface.

33. The brake disk of claim 32 wherein the enamel coating is applied to the main body completely and including the first braking surface and the second braking surface.

34. The brake disk of claim 32 wherein the enamel coating has a thickness of from 50 to 1000 μm.

35. The brake disk of claim 32 wherein the main body has a first outer edge formed on the first braking surface and a second outer edge formed on the second braking surface, wherein the first outer edge and the second outer edge each have a radius R that is three times larger than a thickness of the enamel coating at the first outer edge and the second outer edge.

36. The brake disk of claim 32 wherein the main body is formed of grey cast iron.

37. The brake disk of claim 32 wherein the enamel coating comprises:
a fused mixture that contains glass-forming oxides as well as borax, feldspar, quartz, fluoride, sodium carbonate, sodium nitrate and opacifiers.

38. The brake disk of claim 37 wherein the enamel coating further comprises:
cobalt oxides, manganese oxides and/or nickel oxides.

39. The brake disk of claim 32 wherein the enamel coating further comprises:
cobalt oxides, manganese oxides and/or nickel oxides.

40. The brake disk of claim 32 wherein the enamel coating is a fused mixture of materials selected from a group consisting essentially of:
glass-forming oxides;
borax;
feldspar;
quartz;
fluoride;
sodium carbonate;
sodium nitrate;
cobalt oxides;
manganese oxides; and
nickel oxides.
